(19) United States
(12) Patent Application Publication
(10) Pub. No.: US 2024/0018443 A1
(43) Pub. Date: Jan. 18, 2024

(54) LAUNDRY COMPOSITION

(71) Applicant: Conopco, Inc., d/b/a UNILEVER, Englewood Cliffs, NJ (US)

(72) Inventors: Christopher BOARDMAN, Llandyrnog (GB); Louise Stephanie CONNELL-FIELDING, Liverpool (GB); Martin Charles CROSSMAN, Eastham, Wirral (GB); Paul FERGUSON, Arrowe Park, Wirral (GB); Matthew Charles HERBISON, Wirral (GB); Maria Fernanda JIMENEZ SOLOMON, Liverpool (GB); Dhanalakshmi THIRUMENI, Bangalore (IN)

(73) Assignee: Conopco, Inc., d/b/a UNILEVER, Englewood Cliffs, NJ (US)

(21) Appl. No.: 18/270,979

(22) PCT Filed: Jan. 11, 2022
(86) PCT No.: PCT/EP2022/050394

§ 371 Date: Jul. 5, 2023

(30) Foreign Application Priority Data
Jan. 13, 2021 (EP) 21151436.9

(51) Int. Cl. C11D 3/20; C11D 3/50; C11D 3/40; C11D 11/00; C11D 1/65

(52) U.S. Cl. CPC C11D 3/2093; C11D 3/50; C11D 3/40; C11D 11/0017; C11D 1/65

(57) ABSTRACT

An ancillary laundry composition comprising 0.25 to 10 wt. % ester oil, free perfume and 0 to 4 wt. % anionic and/or cationic surfactant. A method of laundering clothes, wherein said composition is added in the wash or rinse stage. A method of preventing colour fade over (10) laundry cycles, wherein fabrics are treated with said composition during each consecutive laundry cycle. Use of said composition to provide an improved colour maintenance or reduced colour fade over consecutive laundry cycles, preferably (10), more preferably (5) laundry cycles.

### FIELD OF INVENTION

The present invention relates to ancillary laundry compositions suitable for providing benefits to fabric during the laundry process.

### BACKGROUND OF THE INVENTION

The consumer preference for ancillary laundry products is growing. Consumers increasingly are looking for laundry products to use in addition to their laundry detergent and fabric conditioner to provide additional or alternate benefits to their fabrics. Such products allow the consumer to tailor their laundry process to suit their needs and preferences.

EP 2469679 discloses scent additives. The compositions disclosed therein comprise polyethylene glycol, free perfume and perfume microcapsules and optionally a dye.

There remains a need for ancillary laundry compositions which deliver new and improved benefits to fabrics during the laundry process. The compositions described herein provide colour care benefits, including colour care for white fabrics.

### SUMMARY OF THE INVENTION

In a first aspect of the present invention is provided a solid ancillary laundry composition comprising:
a. Ester oil
b. Free perfume
c. 0 to 4 wt. % anionic and/or cationic surfactant.

In a second aspect of the present invention is provided a method of laundering clothes, wherein a composition as described herein is added in the wash or rinse stage.

In a third aspect of the present invention is provided a use of a composition as described herein to provide an improved colour maintenance or reduced colour fade over consecutive laundry cycles, preferably 10, more preferably 5 laundry cycles.

In a fourth aspect of the present invention is provided a use of a composition as described herein to provide improved colour maintenance for white fabrics, i.e. maintenance of the ‘whiteness’ of a fabric.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Ancillary Laundry Compositions

An ancillary laundry composition in the context of the present invention is a laundry composition intended for use in addition to a traditional detergent or fabric conditioner formulation. The ancillary laundry composition provides an additional benefit over and above those delivered by a detergent or fabric conditioner and they provide the consumer with the ability to customise the levels of benefit agents delivered in the wash.

The ancillary laundry composition is in a solid form.

### Ester Oil

The compositions of the present invention preferably comprise ester oils. The ester oils are preferably hydrophobic.

The ester oil may be a sugar ester oil or an oil with substantially no surface activity. Preferably the oil is a liquid or soft solid.

Preferably, the ester oil is a polyol ester (i.e. more than one alcohol group is reacted to form the polyol ester). Preferably the polyol ester is formed by esterification of a polyol (i.e. reacting a molecule comprising more than one alcohol group with acids). Preferably the polyol ester comprises at least two ester linkages. Preferably the polyol ester comprises no hydroxyl groups.

Preferably the ester oil is a pentaerythritol ester oil, i.e. an ester oil formed from pentaerythritol e.g. a pentaerythritol tetraisostearate. Exemplary structures of the compound are (I) and (II) below:

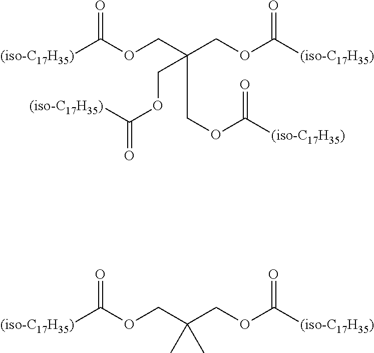

Preferably the ester oil is saturated.

Preferably, the ester oils are esters containing straight or branched, saturated or unsaturated carboxylic acids.

Suitable ester oils are the fatty ester of a mono or polyhydric alcohol having from 1 to about 24 carbon atoms in the hydrocarbon chain and mono or polycarboxylic acids having from 1 to about 24 carbon atoms in the hydrocarbon chain with the proviso that the total number of carbon atoms in the ester oil is equal to or greater than 16 and that at least one of the hydrocarbon radicals in the ester oil has 12 or more carbon atoms.

Preferably the viscosity of the ester oil or mineral oil is from 2 mPa·s to 400 mPa·s at a temperature of 25 C, more preferably a viscosity from 2 to 150 mPa·s, most preferably a viscosity from 10 to 100 mPa·s.

Preferably the refractive index of the ester oil is from 1.445 to 1.490, more preferred from 1.460 to 1.485.

The ester oil of the current invention may be in the form of a free oil or an emulsion.

The ester oil may be encapsulated. Suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules. Suitable microcapsules are disclosed in US 2003215417 In one embodiment, the microcapsules shell maybe coated with polymer to enhance the ability of the microcapsule to adhere to fabric, as described in U.S. Pat. Nos. 7,125,835; 7,196,049; and 7,119,057.

The compositions described herein preferably comprise 0.25 to 10 wt. % ester oil. Preferably 0.5 to 10 wt. % ester oil, more preferably 0.5 to 6 wt. % ester oil.

### Perfume

The compositions of the present invention comprise perfume i.e. free oil perfume or non-confined perfumes. The compositions my preferably also comprise perfume microcapsules.

The compositions of the present invention may comprise one or more perfume compositions. The perfume compositions may be in the form of a mixture of free perfume compositions or a mixture of encapsulated and free oil perfume compositions.

Preferably the compositions of the present invention comprise 0.5 to 20 wt. % perfume ingredients, more preferably 1 to 15 wt.% perfume ingredients, most preferably 2 to 10 wt. % perfume ingredients. By perfume ingredients it is meant the combined free perfume and any encapsulated perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA).

These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20 wt. %, more preferably 0.1 to 15 wt. %, more preferably from 0.1 to 10 wt.%, even more preferably from 0.1 to 6.0 wt. %, most preferably from 0.5 to 6.0 wt. %, based on the total weight of the composition.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume 30 ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the composition.

### Anionic and Cationic Surfactants

The compositions of the present invention are not a traditional laundry detergent or fabric conditioning compositions. The compositions of the present invention preferably comprise low levels or most preferably no anionic or cationic surfactant.

The compositions preferably comprise 0 to 4 wt. % anionic and/or cationic surfactant, preferably 0 to 2 wt. % anionic and/or cationic surfactant, more preferably, 0 to 1 wt. % anionic and/or cationic surfactant, even more preferably 0 to 0.85 wt. % and most preferably 0 to 0.5 wt. % anionic and/or cationic surfactant. The composition can be completely free of anionic and cationic surfactant.

### Carrier Materials

The carrier material, i.e. the material which constitutes the majority of the ancillary laundry composition is a solid material. The compositions described herein comprises at least 50 wt. % carrier materials, preferably 65 wt. %, more preferably 80 wt. % and most preferably at least 90 wt. % carrier materials, by weight of the composition.

The carrier material may be any material which disperses, dissolves, disintegrates or solubilises in water. The composition my comprise one carrier material or a combination of different carrier materials.

The carrier material may be selected from the group consisting of: synthetic polymers (eg, polyethylene glycol, ethylene oxide/propylene oxide block copolymers, polyvinyl alcohol, polyvinyl acetate, and derivatives thereof), proteins (e.g., gelatin, albumin, casein), saccharides (e.g. dextrose, fructose, galactose, glucose, isoglucose, sucrose), polysaccharides (e.g., starch, xanthan gum, cellulose, or derivatives thereof), water-soluble or water dispersible fillers (e.g. sodium chloride, sodium sulfate, sodium carbonate/bicarbonate, zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120), urea and combinations thereof.

Examples of suitable carrier materials include: water soluble organic alkali metal salt, water soluble inorganic alkaline earth metal salt, water soluble organic alkaline earth metal salt, water soluble carbohydrate, water soluble silicate, water soluble urea, starch, xanthan gum, dextrose, clay, water insoluble silicate, citric acid carboxymethyl cellulose, fatty acid, fatty alcohol, glyceryl diester of hydrogenated tallow, glycerol, polyvinyl alcohol, non-ionic surfactants sold under the trade name Lutensol ex. BASF and combinations thereof.

Preferred carrier materials may be selected from the group consisting of synthetic polymers (e g, polyethylene glycol, ethylene oxide/propylene oxide block copolymers, polyvinyl alcohol, polyvinyl acetate, and derivatives thereof), polysaccharides (e.g., starch, xanthan gum, cellulose, or derivatives thereof), saccharides (e.g, dextrose, fructose, galactose, glucose, isoglucose, sucrose), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

More preferably the carrier is selected from polyethylene glycol, starch, dextrose, coconut soap beads, palm soap and combinations thereof.

Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG are: Polyglycol 8000 ex Clariant and Pluriol 8000 ex BASF.

Saccharides are molecular compounds comprising carbon, hydrogen and oxygen. For the purposes of this invention a saccharide is defined as comprising one to ten monosaccharide units and mixtures thereof. In other words either a monosaccharide or an oligosaccharide or mixtures thereof. An oligosaccharide is a short saccharide polymer, typically considered in the art to comprise between two and ten monosaccharides units. It is preferred that a saccharide comprises 1 to 5 monosaccharide units, more preferably 1 to 4 monosaccharide units, most preferably the saccharide comprises monosaccharides, disaccharides or mixtures thereof. Disaccharides are the product of a reaction between two monosaccharides. They may be formed from two identical monosaccharides or two different monosaccharides. Examples of disaccharides include: sucrose, maltose, lactose. Monosaccharides are simple sugar units having the general formula (CH₂O)ₙ. Commonly n is 3, 5 or 6. According, monosaccharides can be classified by the number n, for example: trioses (e.g. glyceraldehyde), pentoses (e.g. ribose) and hexoses (e.g. fructose, glucose and galactose). Some monosaccharides may be substituted with additional functional groups, e.g. Glucosamine, others may have undergone deoxgenation and lost an oxygen atom e.g. deoxyribose. Therefore, the general chemical formulae can vary slightly depending on the monosaccharide.

Preferred monosaccharides for the present invention are hexose molecules (n=6). Hexose molecules all have the same molecular formula, however, have a different structural formula, i.e. are structural isomers. It is preferred that the hexose comprises a 6-membered ring, opposed to a 5 membered ring. Glucose and galactose have 6-membered rings. In a preferred embodiment the hexose monosaccharide is glucose. Glucose is a chiral molecule, having a mixture of D and L stereo isomers. Particularly preferably, the glucose of the present invention is the D isomer of glucose, also known as dextrose.

Preferably a saccharide material used in the present invention is anhydrous, i.e. free of any water. For example, dextrose monohydrate contains one molecule of water whereas anhydrous dextrose contains none.

Non-limiting examples of suitable saccharides for the present invention are: C*Dex ex Cargill, Treha ex Cargill, Anhydrous Dextrose ex Foodchem.

When a saccharide is used in the present invention, it may be preferable to include bitter material such as Bitrex ex Johnson Matthey Fine Chemicals, due to the sweetness of the saccharide.

Preferred ethoxylated non-ionic surfactants have a general formula RO(C₂H₄O)xH, wherein R is a saturated alcohol having a carbon chain of C12 to C20 and wherein x is 8 to 120, preferably 25 to 90 and most preferably 45 to 85.

### Non-Ionic Surfactants

The ancillary laundry composition may preferably comprise non-ionic surfactant. If the ancillary laundry composition is a solid, having ethoxylated non-ionic surfactants as carrier materials, an additional non-ionic surfactant may also be present. Preferably the composition comprises 0.5 to 15 wt. % non-ionic surfactant, more preferably 0.5 to 10 wt. % non-ionic surfactant, most preferably 0.5 to 6 wt. % non-ionic surfactant. The correct amount of non-ionic surfactant is important to achieve the desired delivery of the perfume. The compositions may require sufficient non-ionic surfactant to carry the benefit agent, however too much non-ionic surfactant will interfere with the action of the laundry liquid or powder with which it is used and will prevent release of the perfume due to insufficient dilution.

The non-ionic surfactants will preferably have an HLB value of 12 to 20, more preferably 14 to 18.

Examples of non-ionic surfactant materials include: ethoxylated materials, polyols such as polyhydric alcohols and polyol esters, alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R¹O(R²O)ₓH

R¹=hydrophobic moiety.

R²=C₂H₄ or mixture of C₂H₄ and C₃H₆ units

x=4 to 120

R¹ preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.

R² preferably comprises at least 50% C₂H₄, more preferably 75% C₂H₄ , most preferably R² is C₂H₄.

x is preferably 8 to 90 and most preferably 10 to 60.

Examples of commercially available, suitable non-ionic surfactants include: Genapol C200 ex. Clariant and Eumulgin CO40 ex. BASF.

### Cationic Polymers

The compositions of the present invention preferably comprise a cationic polymer. This refers to polymers having an overall positive charge. The compositions preferably comprise a cationic polymer at a level of from 0.1 to 5 wt. %, preferably from 0.1 to 4 wt. %, more preferably from 0.1 to 3 wt. %, even more preferably from 0.25 to 2.5 wt. %, most preferably from 0.25 to 1.5 wt. %.

The cationic polymer may be naturally derived or synthetic. Examples of suitable cationic polymers include: acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

### Polysaccharide-Based Cationic Polymers

Polysacchride based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

A preferred polysaccharide polymer is cationic cellulose. This refers to polymers having a cellulose backbone and an overall positive charge.

Cellulose is a polysaccharide with glucose as its monomer, specifically it is a straight chain polymer of D-glucopyranose units linked via beta 1,4 glycosidic bonds and is a linear, non-branched polymer.

The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

A preferred class of cationic cellulose polymers suitable for this invention are those that have a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

Example cationic cellulose polymers are salts of hydroxyethyl cellulose reacted with trimethyl ammonium substituted epoxide, referred to in the field under the International Nomenclature for Cosmetic Ingredients as Polyquatemium 10 and is commercially available from the Amerchol Corporation, a subsidiary of The Dow Chemical Company, marketed as the Polymer LR, JR, and KG series of polymers. Other suitable types of cationic celluloses include the polymeric quaternary ammonium salts of hydroxyethyl cellulose reacted with lauryl dimethyl ammonium- substituted epoxide referred to in the field under the International Nomenclature for Cosmetic Ingredients as Polyquatemium 24. These materials are available from Amerchol Corporation marketed as Polymer LM-200.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is a quaternised hydroxy ether cellulose cationic polymer. These are commonly known as polyquaternium-10. Suitable commercial cationic cellulosic polymer products for use according to the present invention are marketed by the Amerchol Corporation under the trade name UCARE. The counterion of the cationic polymer is freely chosen from the halides: chloride, bromide, and iodide; or from hydroxide, phosphate, sulphate, hydrosulphate, ethyl sulphate, methyl sulphate, formate, and acetate.

### Non Polysaccharide-Based Cationic Polymers

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consists of only one type of structural unit, i.e., the polymer is a homopolymer. The cationic polymer may consists of two types of structural units, i.e., the polymer is a copolymer. The cationic polymer may consists of three types of structural units, i.e., the polymer is a terpolymer. The cationic polymer may comprises two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N,N-dialkyl acrylamide, N,N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N,N-dialkylaminoalkyl methacrylate, N,N-dialkylaminoalkyl acrylate, N,N-dialkylaminoalkyl acrylamide, N,N-dialkylaminoalkylmethacrylamide, methacylamidoalkyl trialkylammonium salts, acrylamidoalkylltrialkylamminium salts, vinylamine, vinylimine, vinyl imidazole, quaternized vinyl imidazole, diallyl dialkyl ammonium salts, and mixtures thereof.

Preferably, the cationic monomer is selected from: diallyl dimethyl ammonium salts (DADMAS), N,N-dimethyl aminoethyl acrylate, N,N-dimethyl aminoethyl methacrylate (DMAM), [2-(methacryloylamino)ethyl]trl-methylammonium salts, N,N-dimethylaminopropyl acrylamide (DMAPA), N,N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and mixtures thereof.

The cationic polymer may comprise a anionic structural units derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

Some cationic polymers disclosed herein will require stabilisers i.e. materials which will exhibit a yield stress in the ancillary laundry composition of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic polysaccharide. Even most preferably the cationic polymer is a cationic cellulose or guar. Most preferably the cationic polymer is a cellulose.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

### Preservatives

The composition of the present invention preferably comprises preservatives. Preservatives are preferably present in an amount of 0.001 to 1 wt. % of the composition. More Preferably 0.005 to 0.5 wt. %, most preferably 0.01 to 0.1 wt. % of the composition.

Preservatives can include anti-microbial agents such as isothiazolinone-based chemicals (in particular isothiazol-3-one biocides) or glutaraldehyde-based products. Also suitable are preservatives such as organic acids, sorbates and benzoates. Examples of suitable preservatives include Benzisothiazoline, Cloro-methyl-isothiazol-3-one, Methyl-isothiazol-3-one and mixtures thereof. Suitable preservatives are commercially available as Kathon CG ex. Dow and Proxel ex Lonza.

### Colourant

The compositions of the present invention preferably comprise a colourant. The colourant may be a dye or a pigment or a mixture thereof. The colourant has the purpose to impart colour to the composition, it is not intended to be a shading dye or to impart colour to the laundered fabrics. A single colourant or a mixture of colourants may be used.

Preferably, the colourant is a dye, more preferably a polymeric dye. Non-limiting examples of suitable dyes include the LIQUITINET range of dyes ex Milliken Chemical.

Preferably the composion of the present invention comprise 0.001 to 2 wt. %, more preferably 0.005 to 1 wt. %, most preferably 0.01 to 0.6 wt. %.

### Optional Ingredients

The compositions of the present invention may contain further optional laundry ingredients. Such ingredients include pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials and antifungals, thickeners, low levels of cationic surfactants such as quaternary ammonium compounds and skin benefit agents.

### Form of Composition

The composition may be in any solid form, for example: powder, pellet, tablet, prill, pastille or extrudate. Preferably the composition in the form of a pastille or extrudate. Pastilles can, for example, be produced using ROTOFORMER Granulation Systems ex. Sandvick Materials.

The solid compositions of the present invention may be formed from a melt. The solid composition can for example, be formed into particles by: Pastillation e.g. using a ROTOFORMER ex Sandvick Materials, extrusion, prilling, by using moulds, casting the melt and cutting to size or spraying the melt.

An example manufacturing process may involve melting the carrier material at a temperature above the melting point of the carrier material, preferably at least 2° C. above the melting point of the carrier material, more preferably at least 5° C. above the melting point of the carrier material. Where more than one carrier materials are used, the melting point is considered to the highest of the melting points of the individual materials. Once melted, the ester oil, perfume and other ingredients may be mixed into the compositions. This is followed by a process in which the melt in cooled and shaped, e.g. extrusion or pastillation.

The solid compositions of the present invention are preferably homogeneously structured. By homogeneous, it is meant that there is a continuous phase throughout the solid product. There is not a core and shell type structure. Any particles present such as perfume microcapsules will be distributed within the continuous phase. The continuous phase is provided predominately by the carrier materials.

The solid compositions may be any shape or size suitable for dissolution in the laundry process. Preferably, each individual particle of the solid composition has a mass of between 0.95 mg to 5 grams, more preferably 0.01 to 1 gram and most preferably 0.02 to 0.5 grams. Preferably each individual particle has a maximum linear dimension in any direction of 10 mm, more preferably 1-8 mm and most preferably a maximum linear dimension of 4-6 mm. The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1-5 mm, more preferably 2-3 mm. the dimensions of the particles of the present invention can be measured using Calipers.

### In Use

The ancillary laundry composition may be added to the laundry process in either the wash or the rinse phase of the laundry process.

The compositions comprise less than 4 wt. % cationic and/or anionic surfactant. Therefore, the ancillary composition alone does not deliver any detersive action, nor does it deliver fabric softening cationic surfactants. The compositions are intended for use in combination with traditional laundry liquids (detergent or fabric conditioner) or powder.

In one aspect of the present invention is provided a method of laundering clothes, wherein a composition as described herein is added in the wash or rinse stage, preferably the rinse stage. In another aspect there is provided a method of preventing colour fade over 10 laundry cycles, preferably 5 laundry cycles, wherein fabrics are treated with the compositions described herein during each consecutive laundry cycle, preferably during the rinse phase of the laundry cycle. A single laundry cycle is defined as washing, rinsing, drying and wearing clothes or using fabrics such as sheets or towels. Preferably when the composition is in solid form, 5 to 100 g, more preferably 10 to 50 g, most preferably 10 to 30 g of the composition is added to the laundry process.

In one aspect of the present invention there is provided the use of the compositions described herein to provide improved colour care or colour maintenance of fabrics. In other words the compositions described herein reduce colour fade over multiple laundry cycles. Preferably this benefit is observable over 10, preferably 5 laundry cycles.

The colour benefits described herein are observable on any fabric comprising dyes. However, the colour care benefits are particularly evident for black and green dyes, in particular the method described herein is particularly effective for reactive black dye 5. Colour fade can be measured using a UV Vis spectrometer, for example the Color i7 Benchtop Spectrophotometer ex. X-rite and is reported using the units E.

The colour care benefits are also observable on white fabrics, wherein the maintenance of the ‘whiteness’ of the fabric is observed.

### Example Compositions

TABLE 1
Solid Compositions

Inclusion % by weight

| Ingredient | 1 | 2 |
|---|---|---|
| PEG 8000 ¹ | 70 | 91.09 |
| Starch ² | 20 | — |
| Ester oil: Pentaerythritol | 3 | 1 |
| Tetrastearate ³ | | |
| Blue dye ⁴ | — | 0.01 |
| Free perfume | 7 | 5 |
| Perfume microcapsules | — | 2 |

PEG 8000 ¹—Polyglycol 8000 ex Clariant
Starch ²—Tapioca C*Creamgel 7001 ex Cargill
Ester oil: Pentaerythritol Tetrastearate ³—Priolube 3987 ex Croda
Blue dye ⁴—Milliken Liquitint Blue HP

TABLE 2
Test compositions

Inclusion by wt. %

| Ingredients | B | 3 |
|---|---|---|
| PEG 8000 ¹ | 65 | 56.9 |
| Dextrose | 26 | 28.5 |
| Perfume oil | 7 | 7 |
| Perfume microcapsules | 2 | 2 |
| Ester oil: Pentaerythritol | 0 | 5.6 |
| Tetrastearate³ | | |

The compositions where prepared by heating the PEG to a temperature above its melting point. The dextrose was then added to the molten PEG with stirring. The remaining ingredients were added with stirring the and the molten material pipetted onto a cold flat ceramic surface to form compressed hemispherical particles.

Colour care for white fabrics was tested by washing three 10 cm×10 cm white woven cotton test monitors with four 10 cm×10 cm cotton test monitors which had been dyed with direct red 83:1 dye.

The washes took place in a Terg-O-Tometer pot with a volume of 500 ml. 2 g/L of the test composition and 3.5 g/L of Persil Non-bio detergent were dispersed in the tergo pot. The seven test monitors (three white and four red) were soaked for 20 minutes, followed by a 15 minute wash cycle. The test monitors were then rinsed twice and dried in a dryer for 20 minutes.

The colour care benefit for the white monitors was assessed using a reflectometer. The L, a and b value of the white monitors was measured before and after washing. Delta E was calculated using the formula:

ΔE=\sqrt{(ΔL)²+(Δa)²+(Δb)²}

TABLE 3
Results

| Formulation | Average Delta E |
|---|---|
| B | 9.4 |
| 3 | 6.5 |

The white test monitors washed with composition 3 had a significantly smaller Delta E value, indicating a smaller colour change. Colour care was improved by the presence of the formulation 3 particles in the wash compared to formulation B particles.

1-11. (canceled)

12. A solid ancillary laundry composition comprising:
a. 0.25 to 10 wt. % ester oil;
b. free perfume; and
a 0 to 4 wt. % anionic and/or cationic surfactant,
wherein the composition comprises at least 50 wt. % of a carrier material selected from synthetic polymers, proteins, saccharides, polysaccharides, vegetable soap, ethoxylated non-ionics, urea and combinations thereof and further wherein the ester oil is a polyol ester.

13. The ancillary laundry composition according to claim 12, wherein the polyol ester comprises at least two ester linkages.

14. An ancillary laundry composition according to claim 12, wherein the ester oil is a pentaerythritol ester oil.

15. The ancillary laundry composition according to claim 12, wherein the composition further comprises 0.01 to 20 wt. % free perfume.

16. The ancillary laundry composition according to claim 12, wherein the composition further comprises perfume microcapsules.

17. The ancillary laundry composition according to claim 12, wherein the composition further comprises a cationic polymer.

18. The ancillary laundry composition according to claim 12, wherein the vegetable soap comprises coconut soap beads, palm soap or both.

19. The ancillary laundry composition according to claim 12, wherein the carrier is polyethylene glycol, starch, dextrose, coconut soap beads, palm soap or a combination thereof.

20. The ancillary laundry composition according to claim 12, wherein the composition further comprises a dye, pigment or both.

21. The ancillary laundry composition according to claim 12, wherein the composition further comprises from 0.001 to 1 wt. % preservative.

22. The ancillary laundry composition according to claim 12 wherein the composition further comprises pH buffering agent, perfume carrier, hydrotrope, polyelectrolyte, anti-shrinking agent, anti-oxidant, anti-corrosion agent, drape imparting agent, anti-static agent, ironing aid, antifoam, pearliser and/or opacifiers, natural oil, processing aid, e.g. electrolytes, hygiene agents, anti-bacterials and/or anti-fungal agent, thickener or a mixture thereof.

23. The ancillary laundry composition according to claim 12 wherein the composition comprises particles whereby the particles individually have a mass from 0.95 mg to 5 grams and a maximum linear dimension in any direction of 10 mm.

24. A method of laundering clothes comprising the steps of adding the composition according claim 12 to a wash or rinse stage of a laundry process and contacting cloths with the composition.

25. The method according to claim 24 wherein the composition does not deliver detersive action and fabric softening cationic surfactants,

26. The method according to claim 24 wherein the composition prevents color fade on cloths being laundered.
